(19) United States
(12) Patent Application Publication
(10) Pub. No.: US 2021/0086196 A1
(43) Pub. Date: Mar. 25, 2021

(54) PROCESS FOR SEPARATION OF DRY FOOD AND FEED MATERIALS USING A TRIBO-ELECTROSTATIC SEPARATOR DEVICE

(71) Applicant: SEPARATION TECHNOLOGIES LLC, Needham, MA (US)

(72) Inventors: Abhishek Gupta, Cambridge, MA (US); Kyle P. Flynn, Moseley, VA (US); Philip Charles Ronsivalli, Walpole, MA (US); Frank J. Hrach, JR., Mansfield, MA (US)

(21) Appl. No.: 17/025,675

(22) Filed: Sep. 18, 2020

Related U.S. Application Data
(60) Provisional application No. 62/903,333, filed on Sep. 20, 2019.

(51) Int. Cl. B03C 7/00; B03C 7/08; A23J 1/12; A23J 1/14; A23L 11/00

(52) U.S. Cl. CPC B03C 7/006; B03C 7/08; A23J 1/12; A23J 1/146; A23V 2250/5482; A23V 2300/18; A23V 2300/10; A23V 2300/31; A23L 11/05

(57) ABSTRACT

A process for fractionating a feed mixture derived from dried brewer's spent grains (BSG) or distiller's grains (DDG) or distiller's dried grains and mixed with solubles (DDGS) is disclosed. The process includes using a single-step tribo-electrostatic separation process and device to separate the feed mixture by supplying the feed mixture to a tribo-electric separator and simultaneously charging and separating the feed mixture into at least two subfractions, with one of the subfractions having a protein composition higher than the feed mixture and higher than that could be obtained otherwise.

### CROSS REFERENCE TO RELATED APPLICATIONS

This application claims priority under 35 USC § 119(e) to U.S. Provisional Patent Application Ser. No. 62/903,333, titled “PROCESS FOR SEPARATION OF DRY FOOD AND FEED MATERIALS USING A TRIBO-ELECTROSTATIC SEPARATOR DEVICE,” filed Sep. 20, 2019, which is incorporated by reference herein in its entirety for all purposes.

### BACKGROUND

### Field of Invention

The present invention relates to a process for upgrading the value of dry, granular food and animal feed materials using a tribo-electrostatic separation process to separate the components of human food and animal feed mixtures based on tribo-electric charging of the particles of the food and feed mixtures, such as a process for the enrichment of protein content from low value by-products and to the resulting products therefrom.

### Background of the Invention

Many ingredients used in human food and animal feed materials consist of dry mixtures of mostly proteins, starches, sugars, fibers, fats and oils. The naturally occurring crops are harvested, cleaned, dried, tempered, milled, and purified as required for their ultimate usage as ingredients in human food and animal feed products. The purification process typically consists of dry physical separation based on particle size, or wet processes that use additional chemicals, alkaline water, acidic water, or other solvents to purify the component of interest and generate by-products that are used as lower value ingredients.

One major category of dry food and feed ingredients are the cereal grains which includes wheat, barley, oats, rice, rye, corn, millet, sorghum, quinoa, and couscous. The cereal grains typically contain relatively high levels of starches, and relatively low levels of protein, fiber, and oils. Dry purification of the cereal grains generally consists of physical separation according to particles size after milling. The more fibrous outermost tissues of the grain kernel result in larger particles than the starch-rich endosperm fraction after milling. This allows a straightforward separation using sieves or classification methods to produce a fiber-rich bran product and a starch-rich flour product.

A second major category of dry food and feed ingredients are the pulses (or legumes) which include peas, lima beans, fava beans, lupin beans, and garbanzo beans. The pulses typically contain lower levels of starches and sugars and higher levels of protein than the cereal grains. The oil content of pulses vary among the crops, but it is generally higher than the cereal grains. Pulses are desirable as a food ingredient for humans and animals due to the higher protein content. Significant development work is and has been conducted by the food ingredient industry to develop modified pulse products with enriched protein content for use as a substitute for traditional uses of cereal grains.

A third major category of dry food and feed ingredients are oilseeds and the meals resulting after removal of the oil for the raw oilseed. Examples of oilseeds are soybean, canola (or rapeseed), sunflower, mustard, cottonseed, sesame, flaxseed, safflower, corn germ, and peanut. The oilseeds are characterized by high oil content, low starch/sugar content, and moderate levels of protein and fiber. The by-product meal resulting after removal of the oil from the raw oilseed is useful as an animal (and potentially a human) feed material. The processing industry is devoting significant effort to develop improved methods of upgrading the protein content from the various oilseed meal by-products.

A fourth major category of feed ingredients are brewer's or distiller's grains, which are the cereal by-product of the brewing or distillation process. Brewer's spent grain (BSG) refers to the solid residue produced as a by-product of beer brewing. BSG consists primarily of barley grain husks and is rich in fiber with some protein. Distiller's grains refer to the solid residue produced as a by-product of distillation processes. Distillers grains are produced using corn, rice, or other grains. Distiller's grains can be dried to increase shelf life and allow the by-product to be transported over long distances for use as an animal feed material. Often the dried distiller's grains (DDG) are mixed with condensed distiller's solubles prior to drying. In this case the dried material is referred to as dried distiller's grains with solubles (DDGS). The production of corn-based DDGS has increased tremendously since the 1990s with the growth of fuel ethanol production.

Food ingredient producers and the general public are interested in improved food ingredients containing for example, higher protein content, reduced gluten, higher soluble fiber content, etc. for the reported health benefits in both humans and animals. However, the process technologies required to produce these improved ingredients should not add incremental risks to health, either real or perceived. For this reason, physical purification processes that do not include the use of solvents or the addition of synthetic chemicals are preferred.

Historically, the dry, purification for food and feed consists of size and density based separation processes such as screening, or air classification. These separation processes are limited to applicability only for materials where there is a significant difference in particle size between the components of interest. For example, size based separation methods are not useful in the separation of wheat gluten from wheat starch where the particle size for both components are similar.

Electrostatic separation processes offer a new approach to purification of dry food ingredients. Electrostatic separation has been applied on the industrial-scale for the past 50 years for the beneficiation of minerals and the recycling of waste materials, but the application to processing of food and feed materials using existing electrostatic separation methods has not yet been demonstrated at commercially significant processing rates.

Electrostatic beneficiation allows for separations based on differences in surface chemistry (work function), electrical conductivity, or dielectric properties. Electrostatic separation systems operate on similar principles. All electrostatic separation systems contain a system to electrically charge the particles, an externally generated electric field for the separation to occur in, and a method of conveying particles into and out the separation device. Electrical charging can occur by one or multiple methods including conductive induction, tribo-charging (contact electrification) and ion or corona charging. Electrostatic separation systems utilize at least one of these charging mechanisms.

Rotating drum electrostatic separation systems have been used in many industries and applications where one component is more electrically conductive than the others. There are multiple variations and geometries used for conductive drum systems, but in general, they operate on similar principles. Feed particles are dispersed onto a rotating drum that is electrically grounded, and then charged by either conductive induction or from an ionizing corona discharge. The electrically conductive particles give up their charge to the surface of the grounded drum. The rotation of the drum causes the conductive particles to be thrown from the surface of the drum and deposited in the first product hopper. The non-conductive particles retain their electrical charge and are pinned to the surface of the drum. Eventually, the electrical charge on the non-conductive particles will dissipate, or the particles will be brushed from the drum, after the drum has rotated so that the non-conductive particles are deposited in the non-conductive particle hopper. In some applications a middlings hopper is placed in between the conductive and non-conductive product hopper. The effectiveness of this type of separation device is limited to particles which are relatively coarse and/or have a high specific gravity, due to the need for all particles to contact the surface of the drum. In addition, particle flow dynamics is important as angular momentum is ultimately responsible for conveying the particles from the surface of the drum to the respective product hoppers. Fine particles and low density particles are easily influenced by air currents and thus less likely to be thrown from the drum in a predictable area.

A method of separating fibers from oilseeds using a conductive drum separator is described in European patent application EP1908355 A1. Examples are shown for fiber removal from protein for de-oiled coarse rapeseed with particle size greater than 315 microns. The results of the separation depend on optimizing the feed drying process to achieve a difference in moisture level (and therefore conductivity difference) between the fibers and kernels to be separated. This observation is consistent with all conductive drum devices which are limited to separations based primarily on conductivity differences between components. Application of this type of electrostatic separation device is limited for food and feed applications where the difference in electrical conductivity between mixture components is large.

The conductive belt separator is a variant of the rotating separator described above. Feed particles are dispersed evenly across the width of an electrically grounded conveyor belt. Particles are also charged, either by conductive induction or ion bombardment. Again, the conductive particles give their electrical charge up to the grounded conveyor belt, while the non-conductive particles retain their charge. The conductive particles fall off of the edge of the belt by gravity, while the charged non-conductive particles are “lifted” off of the surface of the belt by electrostatic forces. Again, for the separation to be effective, each particle must contact the surface of the belt to allow for the conductive particles to give up their charge to the belt. Therefore, only a single layer of particles can be conveyed by the separator at one time. As the particle size of the feed becomes smaller, the processing rate of the device is reduced.

A method for separating fibers from corn flour using a conductive belt separator is described in US patent application US20160143346 A1. Examples are shown where fiber is removed from coarse corn flour with particle size greater than 704 microns. As in the case of the rotating drum example, the application of this type of device is limited to relatively coarse particle size, and materials where the mixture components exhibit a difference in electrical conductivity that can be exploited.

Parallel plate electrostatic separators are based upon separating particles not on the basis of conductivity, but on differences in surface chemistry that allows for electrical charge transfer by frictional contact, or tribo-charging. Particles are electrically charged by vigorous contact with other particles, or with a third surface such as a metal or plastic with the desired tribo-charging properties. Materials that are electronegative (located on the negative end of the tribo-electric series) remove electrons from the tribo-charging surface and thus acquire a net negative charge. Materials that are on the positive end of the tribo-electric series donate electrons and charge positive. The charged particles are then introduced into an electrical field generated between the two parallel plate electrodes by various transportation means (gravity, pneumatic, vibration). In the presence of the electric field, the charged particles are deflected and move towards the oppositely charged electrodes and are collected at the corresponding product hoppers. A middlings fraction containing a mixture of particles may be collected, depending on the configuration of the separation device.

A method for processing pulses, grains, oilseeds, and dried fruit using a tribo-charger and a separate vertical parallel plate separator is described in US patent application US20150140185 A1. Examples are shown for separation of protein from starch, and protein from starch and fiber for navy bean flour, quinoa flour, and a synthetic mixture of soy flour and corn starch. Tribo-charging was accomplished in a separate step by contacting the feed particles with a PTFE surface using a custom built “tribo-gun” with internal channels coated with PTFE. After tribo-charging, the feed material was separated using a vertical plate device where 40 mg of each stream was collected, dried, and tested for protein content. The experiments appear to have been conducted at laboratory-scale. The feed rate used for the experiments was not disclosed.

Another method of separating fiber from protein for oilseed cakes using a two-step tribo-electrostatic fractionation process is described in US patent application US20160310957 A1. In this process the feed particles are first processed in a tribo-charging step using fluidized air to create electrostatic charges on the moving particles, and then separated using a vertical parallel plate electrostatic sorter where the particles fall and the paths are deviated by the effect of the electric field applied by the vertical parallel plate electrodes. The device is laboratory scale with electrode dimensions 30 cm high×10 cm wide. There is no disclosure of the feed rate used in the device. The vertical electrodes include a means for mechanically scraping the electrodes to remove the particles that adhere to the electrodes during operation. An alternative method of electrode cleaning is described where the polarity of the electric field is periodically reversed to encourage removal the particles that adhere to the electrode during operation. Examples are shown for separation of protein from lignin for sunflower cake and rapeseed cake that was milled to less than 250 micron and both single and twice passed through the separator. Results show significant increase in protein content in the fraction obtained on one of the electrodes and a decrease in protein for the fraction obtained on the opposite electrode. It is not disclosed whether the sample collected was scraped from the electrode or collected in a receiver below the device.

The usefulness of vertical plate electrostatic separators for high rate industrial-scale applications is limited by the fundamental physics associated with deviating the path of particles falling through a separation chamber. In the design of a vertical plate separator, there are at least three forces acting on the particles as they are deviated horizontally from the action of an electric field that is perpendicular to the path of a vertically falling individual particle. The gravitational force moves the particle downward is proportional to the cube of the diameter and directly proportional to the particle density for spherical particles. The electrostatic force on a spherical particle in an electric field is proportional to the square of the particle diameter and directly proportional to the electric field strength. The aerodynamic drag for a spherical particle is proportional to the square of the particle velocity and the particle diameter. By considering these forces for a typical electric field strength in a free-fall vertical plate separator, and the maximum surface charge density that can be achieved on a particle surface, one can show that the ratio of horizontal (deflecting) velocity (vₕ) to vertical (terminal, falling) velocity (vₜ) will significantly vary with particle size. In one example, the velocity ratio (vₕ/vₜ) will vary from 0.4 for 300 micron particles to 8.0 for 10 micron particles. One can show that the optimum height (H) to electrode gap (G) ratio for a free-fall vertical plate separator is equal to 2×vₕ/vₜ. Therefore, the optimum dimensions for a free-fall vertical plate separator depends strongly on the feed particle size. A practical designer would choose dimensions suitable for optimum separation of the most frequently occurring particles (the mode of the feed particle size distribution). Particles that are significantly larger than the mode will not deflect significantly at the discharge of the vertical plate separator and must be collected separately in a middling fraction stream that must be re-ground and recycled to the feed. Particles that are significantly finer than the mode will travel to the vertical plate electrode surface and tend to collect and adhere to the electrodes. For this reason, it is not possible to design a vertical plate separator with dimensions that allow efficient separation of the entire range of particle sizes produced when using standard industrial milling equipment.

Another factor that limits the effectiveness of vertical plate separators is the effect of charges on the particles on the effective electric field in the separation zone. This is known as the space charge effect. When charged particles are introduced between electrode plates, the charges on the particles interact with the charges on the electrode plates and reduce the local electric field. The magnitude of this effect can be estimated using Gauss' law, which states that the electric field flux depends on the magnitude of the total net charge in a control volume. As one moves away from the electrode surface, the electric field is reduced by the presence of charged particles between the point and the surface of the electrode. When the charge in space is equal to the charge on the electrode surface, there is no electric field, and therefore no further particle separation for a vertical plate device. This creates a feed rate limitation inherent to vertical plate electrostatic separators for a given electric field strength and a given electrode width.

The fluidization characteristic of powders is one parameter useful for determining how the particles of the powder behave in tribo-electrostatic separators. Section 3.5 in Pneumatic Conveying of Solids by Klinzig G. E. et al., second edition 1997, describes materials loosely as “aeratable” or “cohesive”. The cohesive particles are generally those with finer particle size, lower specific gravity, non-spherical particle shape, and higher surface moisture. Finely milled, charged particles behave as a cohesive powder that adhere to inside surfaces of any processing device creating layers that can build-up over time. Cohesive powders adhere especially well to the surface of the electrodes needed to create the electric field in an electro-static separator. The build-up of cohesive powders on the surface of the electrodes disrupts the applied electric field and results in a deterioration of separation performance. As a result, it is necessary that some type of electrode scraping, or cleaning, mechanism be used to allow for continuous operation of vertical plate separators. This mechanism is complex due to the requirements of electrical isolation of the required high voltage. Furthermore, many bench-top vertical plate separator experiments are conducted in a batch mode where product samples are collected by opening the separator chamber after the experiment and scraping material that has been collected on the electrodes for analysis. This type of results does not allow prediction of separation performance under continuous operation.

To overcome some of the limitations of vertical plate electrostatic separators, The tribo-electric belt separator (TBS) has been developed by commonly-owned Assignee of this application. FIG. 1 shows a tribo-electric belt separator system 10 such as is disclosed in commonly-owned U.S. Pat. Nos. 4,839,032 and 4,874,507, which are hereby incorporated by reference in their entirety. Tribo-electric belt separators (TBS) are used to separate the constituents of particle mixtures in the minerals and recycling industries. One embodiment of belt separator system 10 includes parallel spaced electrodes 12 and 14/16 arranged in a longitudinal direction to define a longitudinal centerline 18, and a belt 20 traveling in the longitudinal direction between the spaced electrodes, parallel to the longitudinal centerline. The belt 20 forms a continuous loop which is driven by a pair of end rollers 22, 24. A particle mixture is loaded onto the belt 20 at a feed area 26 between electrodes 14 and 16. Belt 20 includes counter-current traveling belt segments 28 and 30 moving in opposite directions for transporting the constituents of the particle mixture along the lengths of the electrodes 12 and 14/16. The only moving part of the TBS is the belt 20. The belt is therefore a critical component of the TBS. The belt 20 moves at a high speed, for example, up to about 20 m/s. The two belt segments 28, 30 move in opposite directions, parallel to centerline 18, and thus if they come into contact, the relative velocity is about 40 m/s.

### BRIEF DESCRIPTION OF DRAWINGS

Certain illustrative features and examples are described below with reference to the accompanying figures in which:

FIG. 1 is a schematic of a tribo-electric belt separator system; and

FIG. 2 is a ternary diagram representing composition ranges of various crops and feeds.

The advantages of the aspect and embodiments of this disclosure may be better understood by referring to the following description when taken in conjunction with the drawings. The drawings are not intended to be drawn to scale. In the drawings, each identical or nearly identical component that is illustrated in various figures is represented by a like numeral. For purposes of clarity, not every component may be labeled in every drawing. It will be recognized by the person of ordinary skill in the art, given the benefit of this disclosure, that the dimensions, sizes, components, and views shown in the figures are for illustrative purposes. Other dimensions, representations, features, and components may also be included in the embodiments disclosed herein without departing from the scope of the description.

### DETAILED DESCRIPTION

The disclosure is not limited in its application to the details of construction and the arrangement of components set forth in the following description or illustrated in the drawings. Aspects of the disclosure capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items. At least one aspect of the present disclosure is directed to a tribo-electric enrichment process and system for the enrichment of protein content from low value by-products such as, for example, those resulting from the brewing, Brewer's spent grains (BSG) and distillation industries, dried distiller's grains with or without solubles (DDGS or DDG) and to the resulting products from the process, particularly the product that is enriched in protein. The higher protein content products can have increased value as an ingredient in animal feed formulations.

In particular, at least one embodiment of the process includes supplying a DDGS/DDG feed mixture to a tribo-electric separator; charging and separating the feed mixture into at least two sub-fractions, with one of the subfractions enriched in protein and having a composition different than the feed mixture. In at least one embodiment, the protein concentration of one of the products of the separator apparatus and process is higher than would otherwise be achievable with the prior art processes or that is naturally occurring.

Corn DDGS/DDG feed produced by conventional methods contains less than 34% protein (usually less than 30% protein). U.S. Pat. No. 8,227,015B2 discloses a process to extract minor amounts of residual oils from DDGS to raise the protein to a maximum of about 35%. It is an object of this disclosure to provide process DDGS and DDG feed mixtures to increase the protein concentration. According to at least one embodiment, it is an object to process such feed mixtures to provide subfractions having a protein composition of at least 40%. According to at least one embodiment, it is an object to process such feed mixtures to provide subfractions having a protein composition of at least 50% protein.

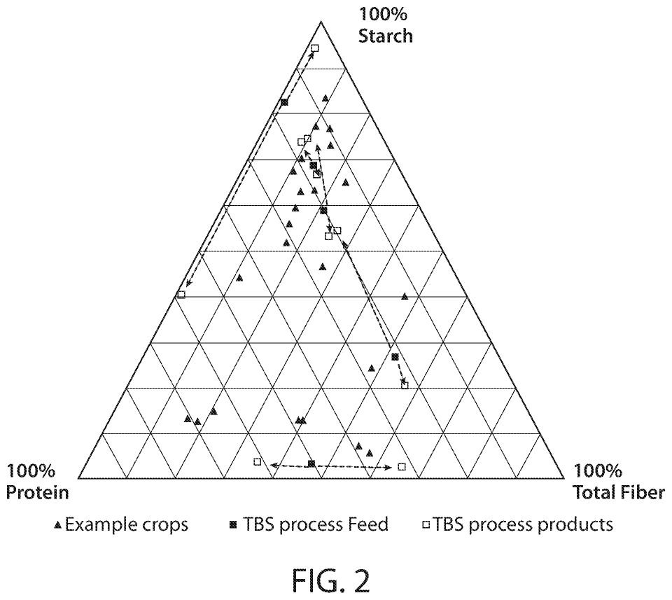

FIG. 2 shows a ternary diagram representation of the typical range of compositions (protein, total fiber, starch/sugars/other carbohydrates) for naturally grown materials in the major categories of food and feed ingredients. For purpose of clarity, FIG. 2 does not display the moisture and oil content that was present in the mixtures during processing. The protein content of food and feed materials is measured using the standard Kjeldahl or Dumas methods. The total fiber content is measured using one of the standard analytical methods such as the gravimetric method AOAC 991.43. The total starch and sugars are measured by polarimetry and various other methods or calculated. The oil content is measured using the standard acid hydrolysis/ether extract method. The moisture content is measured using the oven drying method. The composition for each of the three solid phase components is expressed as a percentage excluding the water and oil fractions.

Each of the green squares represent the composition of a particular crop that is used as a food ingredient or animal feed product. The soluble fiber content for these example crops is not included in the fiber measurements. The blue squares represent composition of the feed materials used in exemplary tests of separating such feed materials using the TBS apparatus and process of this disclosure. The red squares represent the composition of the product and by-product materials produced for each example separation. The dashed arrows indicate the range of composition achieved from each example test separation of a feed material. It is important to note that the feed materials used for the example separations using the TBS apparatus and process contained various amounts of water and oil, and that the feed material input and the resulting outputs are presented as % protein, % insoluble fiber, and % starch/sugar/other carbohydrates, normalized to 100% by ignoring the water and oil content for each sample.

Examination of FIG. 2 reveals that the range of exemplary feed materials and outputs that separated using the TBS apparatus and process of this disclosure form a region that includes most of the various crops (green squares) that are used as food ingredient or animal feed products. Thus, it is reasonable to assume that the TBS separation apparatus and process can be used for the other example crops shown (and not shown in FIG. 2) that both fall within the region that were tested in the examples and it is also reasonable to assume that the crops that are not within the illustrated regions would also be able to be separated by the TBS apparatus and process to yield similar results given the limited number of tests that were run (not of all the crops were subjected to testing). Thus, as is evident from the examples and discussion, it is reasonable to conclude that the TBS process and apparatus of this disclosure can be used on naturally occurring crops (as well as pre-processed crops) other agricultural products, by-products, and waste materials having a moisture content and/or an oil content, at commercially significant processing rates to simultaneously charge and separate the crops into two streams each enriched in at least one of protein, fiber or starch.

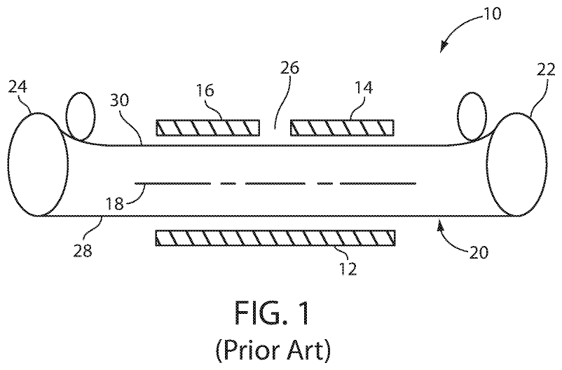

The present disclosure relates to a novel process for fractionating granular food and animal feed materials that exist in the regions depicted in FIG. 2 into their constitutive components using the tribo-electric belt separator (TBS) and process. The apparatus of FIG. 1 and the process are effective at processing dry, granular food and feed materials in a single-step separation process, as a continuously operating process, at commercially significant processing rates. By single step process, what is meant is that the constituents to be a separated are simultaneously tribo-electrically charged, conveyed and separated. The process is applicable to the fractionation of various cereal grains, pulses, oilseeds, cocoa, coffee, and other agricultural products, by-products, and waste materials. The process has particular application in the enrichment of protein content of food and feed materials by separating the protein particles from starch and sugar particles, and separating protein particles from fibers. Aspects and embodiments of the process have a particular benefit for the separation of dried distiller's grains resulting from the brewing and distillation industries mixed with solubles (DDGS) to enrich the protein content of at least one of the resulting products from the process. Another application is in the enrichment of starch content in food and feed materials by removal of residual fiber and protein. Other applications include consequential enrichment of various health promoting components, such as beta-glucan. In other embodiments of the invention, other constituents of natural materials may be enriched or separated from a mixture containing micronutrients, vitamins, trace elements, color, phytochemicals, or minerals.

The TBS operates as a single-step device where the food and feed particles are simultaneously tribo-charged by the frequent particle to particle collisions that occurs in the single device through the action of the special high-speed continuous-loop belt, conveyed and separated. Electrostatic separation processes based on tribo-charging are superior, and have wider application, than those based on charging by conductive induction or ion bombardment because separation can be achieved for a larger variety of particles with subtle differences in surface chemistry (or surface work function). Because the particle number density is so high within the electrode gap and the flow is vigorously agitated by the high speed belt, there are many collisions between particles in the device, and optimal tribo-charging occurs continuously throughout the separation zone. The counter-current flow induced by the motion of the continuous-loop belt creates counter-current multi-stage separation within the TBS device.

In contrast to the TBS apparatus and process according to this disclosure, vertical plate electrostatic separators all require a separate upstream processing step to tribo-charge the feed particles prior to separation by the vertical plate separator. For vertical plate separators, the tribo-charging step may require that each particle contacts a special solid surface with particular surface properties to enable differential charge to develop on the surface of particles. However, the need for each feed particle to contact a special solid surface creates a significant limitation on the maximum processing rate that can be achieved with a vertical plate separator for a compact device.

An issue with separating food and feed materials is that they tend to be cohesive powders that adhere especially well to the surface of the electrodes needed to create the electric field in an electro-static separator. An advantage of the motion of the high speed continuous loop belt in the TBS device and process of this disclosure is that it continuously scrapes the electrodes, which aids in removing the cohesive feed and feed materials from the electrodes and depositing them in the appropriate product hopper. The high speed continuous loop belt is the only moving part in the TBS device and process, and by its design and high speed motion it simultaneously conveys and tribo-charges the feed material, and the belt also provides a system to continuously clean electrodes of cohesive feed and feed materials that adhere to the electrodes. This feature enables the TBS apparatus and process of this disclosure to operate continuously without the need for complex electrode scraping mechanisms or electrode polarity switching systems that are required for vertical plate processes.

One advantage of the TBS apparatus and process of this disclosure, as illustrated by the test examples disclosed herein and illustrated in FIG. 2, is that the TBS apparatus and process can be used to separate feed materials, often in their naturally occurring state with their naturally occurring moisture and oil content (that little to no pre-processing is necessary) to achieve separation of the feed content into two enriched streams of at least one of protein, fiber or starch. It is also appreciated that the moisture content of feed material for the TBS apparatus and process can be adjusted to a range that optimizes the particle tribo-charging and therefore optimizes the resultant separation results. The optimal moisture level can depend on the nature of the feed material and will typically vary between 0% and 30%, and preferably between 0.2 and 11%. Adjustment of feed moisture is advantageous for some food and feed materials, but it is not a necessary requirement to adjust the moisture level of food and feed materials to achieve satisfactory separation results for some materials using the TBS device and process of this disclosure. For example, in the example described below, the separation results were achieved when processing feed materials as-received, that is with moisture levels as occurred naturally in the growing, harvesting, and milling process. This observation demonstrates a unique feature and advantage of the TBS apparatus and process of the disclosure, which is that the single step tribo-charging and separating that occurs in the TBS process is adequate to charge the individual components to be separated without the need for a preliminary feed drying, or wetting, or a separate tribo-charging step.

According to aspects and embodiments disclosed herein, the TBS device and process can be operated with belt speed between 10 and 70 feet per second, preferably between 45 and 65 feet per second; the voltage applied to the electrodes of the TBS apparatus and process electrodes can vary between 3 kV and 20 kV, preferably between 10 and 16 kV; that the gap between the electrodes is continuously adjustable and can be varied between 0.5 to 2.5 cm, preferably between 0.9 to 1.7 cm.

Examples of separation results obtained from sat least one feed materials are detailed in the following example, and the ranges of products and by-products achieved for each example is shown graphically in FIG. 2.

### Example 1: Enrichment of Protein from DDGS

A sample of corn-based distillers dried grains with solubles (DDGS) was prepared for testing using the TBS apparatus and process to demonstrate the capability of the TBS apparatus and process to simultaneously charge and separate distinct protein and starch particles using the TBS apparatus and process in a single step. The sample was milled using a hammer-type mill to a median particle size of approx. 187 micron, contained 8.8% moisture after milling. The sample contained approximately 6% oil, as measured by the ether extraction method. The feed sample was fed as-received, with no adjustment to the moisture content, into the TBS separator at a rate of 40 kg per hour per meter of TBS electrode width. The TBS belt speed was set at 45 feet per second, and 8 kV was applied across the TBS electrode gap to produce an electric field strength of 790 kV/m. Two resulting products were collected from the two ends of the separator. There was no middling fraction that needed to be re-processed. The mass yields of the two products, the composition of the feed and the products are shown in table 1 below:

TABLE 1
Results from testing corn-based DDGS

| | | Product 1 | Product 2 |
|---|---|---|---|
| Run ID | | (Enriched | (Enriched |
| 190423-X3.7-1 | Feed | Fiber) | Protein) |
| Mass | 100% | 46% | 54% |
| Protein | 33.6% | 24.9% | 40.7% |
| (dry basis) | | | |
| Moisture | 8.8% | — | — |
| Fiber (ADF) | 9.9% | 11.4% | 9.0% |
| Fiber (NDF) | 23.4% | 32.8% | 15.6% |
| Oil | 6.4% | % | % |
| Starch | 5.7% | 5.0% | 6.6% |
| Fiber (NDF) | | 64% | 36% |
| Recovery | | | |
| Protein | | 34% | 66% |
| Recovery | | | |

This example demonstrates the capability of TBS process to effectively tribo-charge and separate distinct protein and fiber particles in a single step from a DDGS feed sample in fine dry powder form, generating product streams enriched in each component.

### Example 2: Enrichment of Protein from Brewers Spent Grain (BSG)

A sample of brewers spent grain was prepared for testing using the TBS apparatus and process to demonstrate the capability of the TBS apparatus and process to simultaneously charge and separate distinct protein and fiber particles using the TBS apparatus and process in a single step. The sample was milled using a hammer-type mill to a median particle size of approx. 320 micron, contained 4.8% moisture after milling. The feed sample was fed as-received, with no adjustment to the moisture content, into the TBS separator at a rate of 71 kg per hour per meter of TBS electrode width. The TBS belt speed was set at 45 feet per second, and 8 kV was applied across the TBS electrode gap to produce an electric field strength of 790 kV/m. Two resulting products were collected from the two ends of the separator. There was no middling fraction that needed to be re-processed. The mass yields of the two products, the composition of the feed and the products are shown in table 2 below:

TABLE 2
Results from testing Brewers Spent Grain

| | | Product 1 | Product 2 |
|---|---|---|---|
| Run ID | | (Enriched | (Enriched |
| 190716-X3.7-2 | Feed | Fiber) | Protein) |
| Mass | 100% | 63% | 37% |
| Protein | 25% | 15.9% | 42.9% |
| (dry basis) | | | |
| Moisture | 4.7% | — | — |
| Fiber | | % | % |
| Ash | | % | % |
| Oil | | | |
| Starch | | | |
| Fiber | | | |
| Recovery | | | |
| Protein | | 39% | 61% |
| Recovery | | | |

This example demonstrates the capability of TBS process to effectively tribo-charge and separate distinct protein and fiber particles in a single step from a spent grain feed sample in fine dry powder form, generating product streams enriched in each component.

### Example 3: Enrichment of Protein from Coarsely Milled Sunflower Meal

A sample of sunflower meal was prepared for testing using the TBS apparatus and process to demonstrate the capability of the TBS apparatus and process a coarsely milled sample of sunflower meal to simultaneously charge and separate distinct protein and fiber particles using the TBS apparatus and process in a single step. The sample was milled using roller-type mill to a median particle size of approx. 415 micron. After milling the sample was dried in a separate step to a moisture level of 2.7% moisture. The feed sample was fed, into the TBS separator at a rate of 12,000 kg per hour per meter of TBS electrode width. The TBS belt speed was set at 15 feet per second, and 12 kV was applied across the TBS electrode gap to produce an electric field strength of 1225 kV/m. Two resulting products were collected from the two ends of the separator. There was no middling fraction that needed to be re-processed. The mass yields of the two products, the composition of the feed and the products are shown in table 3 below:

TABLE 3
Results from Sunflower Meal Testing

| | | Product 1 | Product 2 |
|---|---|---|---|
| Run ID | | (Enriched | (Enriched |
| 190730-A2 | Feed | Fiber) | Protein) |
| Mass | 100% | 36% | 64% |
| Protein | 40.7% | 17.6% | 51.7% |
| (dry basis) | | | |
| Moisture | 2.7% | — | — |
| Fiber | | % | % |
| Ash | | % | % |
| Oil | | | |
| Starch | | | |
| Fiber | | | |
| Recovery | | | |
| Protein | | 16% | 84% |
| Recovery | | | |

This example demonstrates the capability of TBS process to effectively tribo-charge and separate distinct protein and fiber particles in a single step from a coarse roller-milled sunflower meal feed sample in coarse dry powder form, generating product streams enriched in each component.

It is appreciated that any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

1. A process for fractionating a feed mixture derived from dried brewer's spent grains (BSG) or distiller's grains (DDG) or distiller's dried grains and mixed with solubles (DDGS), comprising using a tribo-electrostatic separation process including:
a. supplying said BSG or DDG or DDGS mixture to a tribo-electric separator; and
b. simultaneously charging and separating said BSG or DDG or DDGS mixture into at least two subfractions, with one of the subfractions having a protein composition higher than the feed mixture and higher than that could be obtained otherwise.

2. The process described in claim 1 using a continuously operating tribo-electrostatic belt separator comprising:
i. a first electrode and a second electrode arranged on opposite sides of a longitudinal centerline and configured to provide an electric field between the first and second electrodes;
ii. a first roller, or rollers, disposed at a first end of the separator
iii. a second roller, or rollers, disposed at a second end of the separator
iv. a continuous belt disposed between the first and second electrodes and supported by the first roller(s) and the second roller(s)
v. a separation zone defined by and between the continuous belt.

3. The process described in claim 1, wherein protein particles are separated from fiber particles for a feed mixture with protein level between 10-40%; and the oil content is less than 20%, and moisture content is less than 30%.

4. The process as claimed in claim 1, wherein the protein level of one of the sub-fractions is enriched to be anywhere in a range of 4% to 90%.

5. The process as claimed in claim 1, wherein the protein level of one of the sub-fractions is enriched to be anywhere in the range of 25% to 60%.

6. The process as claimed in claim 1, wherein the protein level of one of the subfractions is enriched by at least a relative change of 5%.

7. The process as claimed in claim 1, wherein the particle size can be anywhere in a range from 12 micron to 400 microns.

8. The process as claimed in claim 1, wherein the median particle size can be anywhere in a range from 187 micron to 320 microns.

9. The process as claimed in claim 1, wherein the moisture percentage can be anywhere from 0% to 10%.

10. The process as claimed in claim 1, wherein the oil percentage content can be anywhere from 0.7% to 12.0%.

11. The process as claimed in claim 1, wherein the feed mixture can be processed at a rate of anywhere in a range of 40 to 17,000 kg per hour per meter of TBS electrode width.

12. The process as claimed in claim 1, wherein the belt speed can be anywhere in a range of 10 to 70 feet per second.

13. The process as claimed in claim 1, wherein the electric field strength can be anywhere in a range of 120 to 4,000 kV/m.

14. A process for fractionating a feed mixture derived from oilseed meals using a tribo-electrostatic separation process, comprising:
a. milling said oilseed mixture to a coarse particle size;
b. drying the coarsely milled oilseed mixture;
c. supplying the milled and dried oilseed mixture to a tribo-electric separator; and
d. simultaneously charging and separating said oilseed mixture into at least two subfractions, with one of the subfractions having a protein composition higher than the feed mixture and higher than that could be obtained otherwise.

15. The process as claimed in claim 14, wherein the tribo-electric separator is a continuously operating tribo-electrostatic belt separator comprising:
i. a first electrode and a second electrode arranged on opposite sides of a longitudinal centerline and configured to provide an electric field between the first and second electrodes;
ii. a first roller, or rollers, disposed at a first end of the separator;
iii. a second roller, or rollers, disposed at a second end of the separator;
iv. a continuous belt disposed between the first and second electrodes and supported by the first roller(s) and the second roller(s); and
v. a separation zone defined by and between the continuous belt.

16. The process as claimed in claim 14, wherein the oilseed mixture is sunflower meal.

17. The process as claimed in claim 14, wherein protein particles are separated from fiber particles for a feed mixture with protein level between 30-40%, wherein the oil content is less than 20%, and wherein the moisture content is less than 30%.

18. The process as claimed in claim 14, wherein the protein level of one of the sub-fractions is enriched to be anywhere in a range of 4% to 90%.

19. The process as claimed in claim 14, wherein the protein level of one of the sub-fractions is enriched to be anywhere in the range of 30% to 60%.

20. The process as claimed in claim 14, wherein the protein level of one of the subfractions is enriched by at least a relative change of 5%.
